(19) United States
(12) Patent Application Publication
(10) Pub. No.: US 2026/0307413 A1
(43) Pub. Date: Oct. 8, 2026

(54) METHOD OF MANUFACTURING TREATED MEDIUM, MANUFACTURING APPARATUS, AND MANUFACTURING SYSTEM

(71) Applicant: BROTHER KOGYO KABUSHIKI KAISHA, NAGOYA (JP)

(72) Inventors: Katsuya ONO, Nagoya (JP); Makito IGUCHI, Nagoya (JP); Shogo SHIBAYAMA, Nisshin (JP)

(73) Assignee: BROTHER KOGYO KABUSHIKI KAISHA, NAGOYA (JP)

(21) Appl. No.: 19/637,111

(22) Filed: Apr. 2, 2026

(30) Foreign Application Priority Data
Apr. 3, 2025 (JP) 2025-062085

(51) Int. Cl. B41M 5/00; B41J 3/407; B41J 11/00

(52) U.S. Cl. CPC B41M 5/0017; B41J 3/407; B41J 11/0015; B41M 5/0047

(57) ABSTRACT

A method of manufacturing a treated medium by performing a treatment on a medium may be provided, in which the medium may be a paperboard in which a coating layer including a binder is disposed on a surface layer of the medium. The method may include heating the medium, and applying ink to the coating layer after the heating. The heating may include, when a heating temperature is X [° C.] and a heating time is Y [minutes], heating the medium such that a relationship of X≥70 and Y>−0.04X+6.165 (where Y>0) is satisfied.

### REFERENCE TO RELATED APPLICATIONS

This application claims priority to Japanese Patent Application No. 2025-062085 filed on Apr. 3, 2025. The entire content of the priority application is incorporated herein by reference.

### BACKGROUND ART

A pre-coating liquid to be applied to a surface of a medium is known. It is known that by applying this pre-coating liquid to the surface of the medium, beading of ink that is subsequently applied on the medium can be suppressed. The term “beading” refers to a phenomenon in which adjacent dots attract each other due to surface tension and agglomerate into beads when ink is fixed on the medium.

### SUMMARY

This document provides novel art that can suppress ink beading.

A method of manufacturing a treated medium by performing a treatment on a medium is disclosed herein. The medium may be a paperboard in which a coating layer comprising a binder is disposed on a surface layer of the medium. The method may include heating the medium, and applying ink to the coating layer after the heating. The heating may include, when a heating temperature is X [° C.] and a heating time is Y [minutes], heating the medium such that a relationship of X≥70 and Y>−0.04X+6.165 (where Y>0) is satisfied.

When a surface of a medium has numerous micro irregularities, adjacent dots are more likely to agglomerate and thus beading is more likely to occur. In the manufacturing method described above, the medium is heated in the heating process under the condition that satisfies the above relationship. In other words, in the above manufacturing method, higher energy is applied to the medium in the heating process than in various treatments generally performed on the medium. The surface layer of the medium comprises the coating layer containing the binder. Therefore, the heating process softens the binder contained in the coating layer and makes the surface of the coating layer flat and smooth. Due to this, when the ink is applied to the surface of the coating layer in the applying process, wettability of the ink is improved and the ink can be applied uniformly to the surface of the coating layer. As a result, the above manufacturing method can be considered as capable of suppressing ink beading.

A manufacturing apparatus configured to manufacture a treated medium by performing a treatment on a medium is also novel and useful. The medium may be a paperboard in which a coating layer comprising a binder is disposed on a surface layer of the medium. The manufacturing apparatus may include a heater configured to heat the medium, and an applier configured to apply ink to the coating layer after the medium has been heated by the heater. The heater may heat the medium such that, when a heating temperature is X [° C.] and a heating time is Y [minutes], a relationship of X≥70 and Y>−0.04X+6.165 (where Y>0) is satisfied.

A manufacturing system configured to manufacture a treated medium by performing a treatment on a medium is also novel and useful. The medium may be a paperboard in which a coating layer comprising a binder is disposed on a surface layer of the medium. The manufacturing system may include a heater configured to heat the medium, and an applier configured to apply ink to the coating layer after the medium has been heated by the heater. The heater may heat the medium such that, when a heating temperature is X [° C.] and a heating time is Y [minutes], a relationship of X≥70 and Y>−0.04X+6.165 (where Y>0) is satisfied.

### BRIEF DESCRIPTION OF DRAWINGS

FIG. 1 illustrates the configuration of a surface treatment system.

FIG. 2 illustrates a graph to describe a relationship between a heating temperature of a medium and a heating time.

FIG. 3 illustrates a part of the graph of FIG. 2 in an enlarged form.

FIG. 4 illustrates a graph illustrating an example of a relationship between the heating temperature of the medium and the heating time.

### DESCRIPTION

### (Configuration of Surface Treatment System 10)

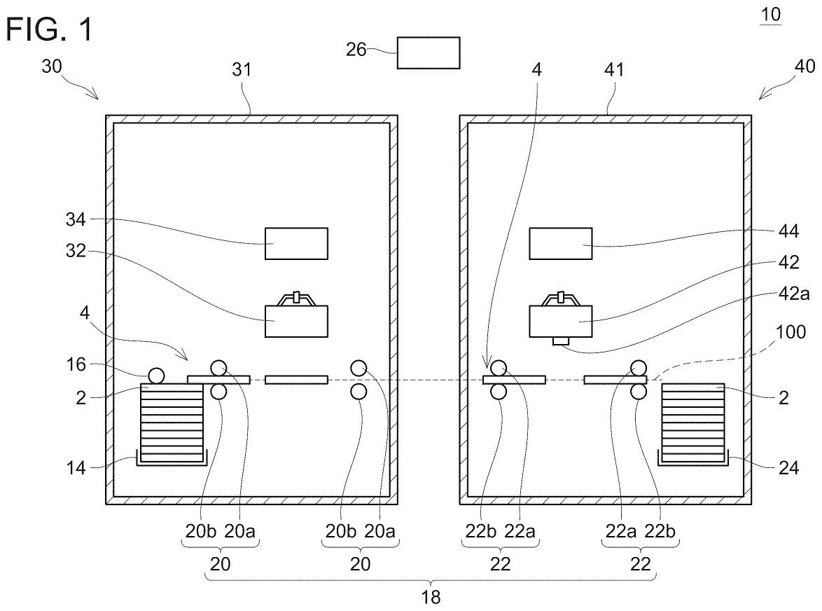

With reference to the drawings, a surface treatment system 10 of an embodiment will be described. As shown in FIG. 1, the surface treatment system 10 comprises a heater 30 and an applier 40. The surface treatment system 10 manufactures a treated medium 2 by heating the medium 2 and then applying ink to the medium 2. By heating the medium 2, surface properties of the medium 2 are modified and ink beading is suppressed. The heater 30 and the applier 40 are used in a state of being placed on a floor or a rack. However, in other embodiments, the heater 30 and the applier 40 may be used in a state of being placed on a desk.

The surface treatment system 10 comprises a feed tray 14, a feed roller 16, a conveyor 18, a feed-out tray 24, and a controller 26. The controller 26 is communicably connected to each unit/device of the surface treatment system 10. Thus, the controller 26 can control each unit/device of the surface treatment system 10.

The feed tray 14 is detachably supported by a housing 31 of the heater 30. The feed tray 14 supports the media 2. A user can take out the feed tray 14 to the outside of the housing 31 to stack the plurality of media 2 in the feed tray 14. After this, the surface treatment system 10 is supplied with the media 2 by the feed tray 14 being placed back into the housing 31.

The feed roller 16 contacts the upper surface of the uppermost medium 2 among the media 2 supported on the feed tray 14. The feed roller 16 is rotated by a conveyor motor. When the feed roller 16 rotates, the uppermost medium 2 is fed from the feed tray 14.

The conveyor 18 is arranged to extend from within the housing 31 of the heater 30 into a housing 41 of the applier 40. The conveyor 18 conveys the medium 2 fed through the feed roller 16 to the feed-out tray 24. The conveyor 18 comprises two first roller pairs 20 and two second roller pairs 22.

Each of the two first roller pairs 20 is arranged in the housing 31 of the heater 30. Each of the two first roller pairs 20 comprises a first conveyor roller 20a and a first pinch roller 20b. Contact between the first conveyor roller 20a and the first pinch roller 20b forms a nip 4. The two first roller pairs 20 are rotated by the conveyor motor. The two first roller pairs 20 rotate while nipping the media 2, to convey the media 2 from the feed roller 16 toward the second roller pairs 22. The number and arrangement of the first roller pairs 20 are not particularly limited.

Each of the two second roller pairs 22 is disposed within the housing 41 of the applier 40. Each of the two second roller pairs 22 comprises a second conveyor roller 22a and a second pinch roller 22b. Contact between the second conveyor roller 22a and the second pinch roller 22b forms a nip 4. The two second roller pairs 22 are rotated by the conveyor motor. The two second roller pairs 22 rotate while nipping the media 2, to convey the media 2 toward the feed-out tray 24. The number and arrangement of the second roller pairs 22 are not particularly limited.

The feed-out tray 24 is disposed in the housing 41 of the applier 40. The media 2 are fed out from the conveyor 18 onto the feed-out tray 24. The feed-out tray 24 supports the media 2.

A conveyance path 100 is formed between the feed tray 14 and the feed-out tray 24. The medium 2 is conveyed on the conveyance path 100 across the heater 30 to the applier 40. As the medium 2 passes through this conveyance path 100, the medium 2 is heated, and ink is subsequently applied to the medium 2.

The heater 30 comprises a heating portion 32 and a controller 34. The heating portion 32 is positioned above the conveyance path 100. The heating portion 32 is composed of, for example, a dryer, a heat gun, an oven, and/or an IR heater. The controller 34 controls the operation of the heating portion 32 based on commands from the controller 26. By controlling the heating portion 32, the controller 34 heats the medium 2 under a condition that satisfies a relationship between a predetermined heating temperature and heating time. The condition will be described below. The specific configuration of the heater 30 is not particularly limited. In this embodiment, the heating portion 32 is arranged above the conveyance path 100, but the heating portion 32 may be arranged below the conveyance path 100, or the heating portions 32 may be disposed both above and below the conveyance path 100. The heating portion 32 may be arranged so that the conveyance path 100 passes through inside the heating portion 32.

The applier 40 is arranged downstream of the heater 30 in the conveyance path 100. The applier 40 comprises a head 42 and a controller 44. The head 42 is disposed above the conveyance path 100. The head 42 comprises a plurality of nozzles 42a. The controller 44 controls the operation of the head 42 based on commands from the controller 26. The controller 44 controls piezoelectric elements, for example, corresponding to the respective nozzles 42a. By controlling the piezoelectric element(s), for example, the controller 44 selectively ejects ink externally through each nozzle 42a using an inkjet method. Thus, ink is selectively ejected from each of the nozzles 42a toward the medium 2 passing through the conveyance path 100, and ink is applied on the surface of the medium 2. The specific configuration of the applier 40 is not particularly limited.

The respective components of the surface treatment system 10 need not necessarily be located in the positions shown in the figures. For example, the feed tray 14 may be arranged outside the housing 31 of the heater 30, and the feed-out tray 24 may be arranged outside the housing 41 of the applier 40. The first roller pairs 20 and the second roller pairs 22 may also be arranged outside of the housing 31 and the housing 41, respectively.

### (Media)

The medium 2 is a paperboard in which a coating layer is disposed on a surface layer of the medium 2. The medium 2 may be a white paperboard or a colored paperboard. The medium 2 comprises a substrate and a coating layer.

### (Substrate)

The substrate is composed of paper material with pulp as a component. The paper material may be multi-layered or single-layered. The thickness of the substrate is not particularly limited. The thickness is, for example, 0.2 mm or more and 0.6 mm or less, or 0.3 mm or more and 0.5 mm or less. That is, the substrate of the medium 2 has a relatively large thickness, and so-called plain paper and thin paper, for example, are not included in the substrate.

### (Coating Layer)

The coating layer is disposed on the surface of the substrate. The coating layer is provided, for example, to add smoothness and glossiness to the surface of a substrate composed of paper material. The coating layer is also provided, for example, to improve barrier property against moisture and oil and durability of the medium 2. This allows the ink to be laid well on the medium 2, suppresses unevenness of the ink, and improves the printability of the medium 2. The thickness of the coating layer is not particularly limited, but is, for example, 1 μm or more and 20 μm or less, or 3 μm or more and 15 μm or less.

The coating layer contains a binder. The binder is not particularly limited, but may include, for example, styrene-butadiene resins; acrylic resins such as a methyl (meth)acrylate copolymer and a styrene-(meth)acrylic copolymer; olefin-unsaturated carboxylic acid copolymers such as ethylene-(meth)acrylic copolymer; and natural polysaccharides such as dextrin, mannan, chitosan, arabinogalactan, glycogen, inulin, pectin, hyaluronic acid, hydroxyethylated starch, oxidized starch, etherified starch, phosphate-esterified starch, enzyme-modified starch, and modified starch obtained by flash-drying these, and oligomers thereof, as well as modified products thereof, and the like. One of these binders may be used alone, or two or more may be used in combination.

The coating layer may contain pigments. The pigments are not particularly limited, and examples thereof include inorganic pigments such as kaolin, clay, engineered kaolin, delaminated clay, calcined clay, ground calcium carbonate, precipitated calcium carbonate, talc, titanium dioxide, barium sulfate, calcium sulfate, zinc oxide, silicic acid, silicates, colloidal silica, and satin white; and organic pigments such as dense-type, hollow-type, or core-shell-type organic pigments.

The coating layer may contain other component(s) such as adhesive, dispersant, thickener, water retention agent, defoaming agent, waterproofing agent, colorant, surfactant, etc. Examples of the adhesive may include, for example, proteins such as casein, soy protein, and synthetic proteins; starches such as oxidized starch, positive starch, etherified starch such as urea phosphate esterified starch, hydroxyethyl etherified starch, and dextrin; cellulose derivatives such as carboxymethyl cellulose, hydroxyethyl cellulose, and hydroxymethyl cellulose, and the like.

### (Surface Free Energy of Coating Layer)

After the medium 2 has undergone heat treatment by the heater 30 of the surface treatment system 10, ink is applied on the surface of the coating layer. In order to improve the wettability and adhesion of the ink on the coating layer, it is preferable that the surface free energy of the coating layer is large. The surface free energy of the coating layer is not particularly limited, but may be, for example, 30 [mN/m] or more, 40 [mN/m] or more, 45 [mN/m] or more, 47 [mN/m] or more, 50 [mN/m] or more. When the surface free energy of the coating layer satisfies the above value, ink beading can be suitably suppressed by applying the art disclosed herein.

The method of controlling the surface free energy of the coating layer to the above value is not particularly limited. Examples of such method include, for example, method of changing the contact angle by selecting the type of binder to be contained; method of changing the contact angle by physically changing the surface microstructure; method of changing the contact angle by introducing functional groups onto the surface through physicochemical treatment such as heat, light, electromagnetic waves, oxidation, reduction, etc.; and a method of changing the contact angle by changing surface physical properties through incorporation of chemical component(s) such as a surface treatment agent such as surfactant or a coupling agent. The surface free energy of the coating layer can be measured in accordance with JIS K6768: 1999.

### (Peak Density Spd of Coating Layer)

Spd indicates the number of peaks per unit area as defined in ISO 25178. The surface of the coating layer has a higher smoothness than the surface of the substrate. However, the surface of the coating layer also has micro unevenness. Therefore, if the number of peaks caused by the unevenness is large, ink applied on the surface of the coating layer is easily guided to the valley portions that exist between the peaks, and beading is easily generated. In the art disclosed herein, the Spd of the coating layer can be reduced by executing a heat treatment on the medium 2 by the heater 30 of the surface treatment system 10. Since the coating layer contains a binder, performing the heat treatment softens the binder contained in the coating layer and smoothes the surface of the coating layer. The coating layer of the medium 2 may, for example, be constituted of a material such that, when the medium 2 is heated at 150° C. for 60 minutes, the Spd is reduced by 10% or more as compared with the Spd before heating. Also, the coating layer of the medium 2 may be constituted of a material such that, when the medium 2 is heated under the same condition, the Spd is 600 [mm⁻²] or less. When the medium 2 with such a coating layer is used, ink beading can be further suppressed by applying the art disclosed herein. It should be noted, however, that the art disclosed herein does not limit the Spd of the coating layer. The coating layer may be constituted not only of a material such that, by heating as described above, the Spd is reduced from over 600 to 600 or less, but also of a material such that the Spd is 600 or less in the state before heating.

### (Thickness of Medium 2)

The thickness of the medium 2 is not particularly limited. The thickness of the medium 2 can be the sum of the thickness of the substrate and the thickness of the coating layer. The thickness of the medium 2 is, for example, 0.2 mm or more and 0.6 mm or less, or 0.3 mm or more and 0.5 mm or less. The thickness of the medium 2 can be measured in accordance with JIS P 8118:2014.

### (Basis Weight of Medium 2)

The basis weight of the medium 2 is not particularly limited. For example, the basis weight is 100 g/m² or more and 700 g/m² or less, and 200 g/m² or more and 600 g/m² or less. The basis weight of the medium 2 can be measured in accordance with JIS P 8124:2011.

The application of the medium 2 is not particularly limited. Examples of uses of the medium 2 include industrial printing applications, general paper containers, and packaging paper. Examples of packaging objects include, for example, food products, confectionery, daily sundries, textile products, tissues, wraps, pharmaceuticals, electronic components, etc.

Commercially available products may be used as the medium 2. Examples of the commercially available products include: for example, “OK BALL” series, “UF Coat” series, “Suncoat (registered trademark)” series, “MC BALL” series, and “Sun Dia White N” series manufactured by Oji Materia Co.; “S-Pearl Card” series (registered trademark) and “N-Pearl Deluxe” series (registered trademark), manufactured by Mitsubishi Paper Mills, Ltd.; “MARICOAT (registered trademark)” series manufactured by Hokuetsu Corporation; and “JETSTAR (registered trademark)” series and “I-Best (registered trademark) WF” series manufactured by Nippon Paper Industries Co.

### (Ink)

Ink is applied onto the coating layer of the medium 2 after the medium 2 is heated by the heater 30. The ink includes, for example, a colorant, resin, and water.

### (Colorant)

Examples of colorants include, for example, pigments and dyes that can be dispersed in water by means of resin dispersant or by self-dispersion. Examples of pigments include carbon black, inorganic pigments, and organic pigments. Examples of carbon black include, for example, furnace black, lamp black, acetylene black, channel black, etc. Examples of the inorganic pigments may include, for example, titanium dioxide, iron oxide-based inorganic pigments, and carbon-black-based inorganic pigments. Examples of the organic pigments may include, for example, azo pigments, polycyclic pigments, dye-lake pigments, nitro pigments, nitroso pigments, and aniline black, daylight fluorescent pigments. Example of other pigments include, for example, C. I. Pigment Black 1, 6, 7, C. I. Pigment Yellow 1, 2, 3, 12, 13, 14, 15, 16, 17, 55, 73, 74, 75, 78, 83, 93, 94, 95, 97, 98, 114, 128, 129, 138, 150, 151, 154, 155, 180, 185, 194, C.I. Pigment Orange 31, 43, C.I. Pigment Red 2, 3, 5, 6, 7, 12, 15, 16, 48, 48:1, 48:3, 53:1, 57, 57:1, 112, 122, 123, 139, 144, 146, 149, 150, 166, 168, 175, 176, 177, 178, 184, 185, 190, 202, 209, 221, 222, 224, 238, 254, C.I. Pigment Violet 19, 196, C.I. Pigment Blue 1, 2, 3, 15, 15:1, 15:2, 15:3, 15:4, 16, 22, 60, C.I. Pigment Green 7, 36, and solid solutions of these pigments, etc. The ink may contain only the pigment or only the dye as its colorant. One of these colorants may be used alone, or two or more thereof may be used in combination.

### (Resin)

Examples of resin include, for example, acrylic resin, urethane resin, vinyl chloride resin, polyester resin, styrene resin, polyolefin resin, vinyl acetate resin, vinyl chloride resin, butadiene resin, benzoguanamine resin, phenol resin, silicone resin, epoxy resin, paraffin resin, fluorine resin, water-soluble resin, and copolymer resins thereof. One type of resin as above may be used alone, or two or more thereof may be used in combination.

Examples of the resin may include resin particles. The resin particles may be incorporated, for example, in an emulsion. The emulsion is, for example, composed of resin particles and water. The resin particles are not dissolved in water, but are dispersed in water within a specific particle size range.

### (Water)

Water may be, for example, ion-exchange water or pure water. The water content may be, for example, the remainder excluding the other components.

### (Other Components)

The ink may further contain a surfactant and a water-soluble organic solvent as other component(s).

### (Surfactant)

The surfactant can be selected as desired based on the intended use. Examples of the surfactant may include, for example, anionic surfactants, nonionic surfactants, cationic surfactants, amphoteric surfactants, acetylenic glycol-based surfactants, fluorinated surfactants, and silicone-based surfactants. The surfactant may be a single surfactant or a combination of two or more surfactants from the above-list.

### (Water-Soluble Organic Solvent)

Examples of the water-soluble organic solvent may include, for example, alkyl alcohols having 1 to 4 carbon atoms such as methanol, ethanol, n-propanol, isopropanol, n-butanol, sec-butanol and tert-butanol; alkylene glycols with alkylene groups having 2 to 6 carbon atoms such as ethylene glycol, propylene glycol, butylene glycol, 1,2-butanediol, triethylene glycol, 1,6-hexanediol, 1,2,6-hexanetriol, thiodiglycol, hexylene glycol, diethylene glycol; lower alkyl ethers of alkylene glycols such as glycerin, ethylene glycol monomethyl (or monoethyl, monopropyl, monobutyl) ethers, diethylene glycol monomethyl (or monoethyl, monopropyl, monobutyl) ethers, triethylene glycol monomethyl (or monoethyl, monopropyl, monobutyl, monohexyl) ethers, tetraethylene glycol monomethyl (or monoethyl, monopropyl, monobutyl, monohexyl) ethers, propylene glycol monomethyl (or monoethyl, monopropyl, monobutyl) ethers, dipropylene glycol monomethyl (or monoethyl, monopropyl, monobutyl) ethers, tripropylene glycol monomethyl (or monoethyl, monopropyl, monobutyl) ethers, and tetrapropylene glycol monomethyl (or monoethyl) ethers; N-methyl-2-pyrrolidone, 2-pyrrolidone and 1,3-dimethyl-2-imidazolidinone. The water-soluble organic solvent may be a single water-soluble organic solvent or a combination of two or more water-soluble organic solvents from the above list.

The ink may further comprise conventionally known additive(s) as needed. Examples of the additive(s) may include, for example, pH adjusters, viscosity modifiers, and preservatives. Examples of the viscosity modifiers may include, for example, polyvinyl alcohol, cellulose, and water-soluble resins.

The ink can be prepared, for example, by uniformly mixing the resin, colorant, the surfactant, water, and other additive(s) if needed, by a publicly known method and then removing undissolved solids through a filter.

### (Surface Treatment Method)

Next, a surface treatment method with the surface treatment system 10 will be described. The surface treatment method comprises a heating process and an application process. The heating process and the application process are executed in this order. The controller 26 starts the steps, for example, in response to a process execution instruction being input to the surface treatment system 10 from an external. When the above instruction is input, the controller 26 controls the units, such as the feed roller 16 and the conveyor 18, to convey the media 2 along the conveyance path 100.

### (Heating Process)

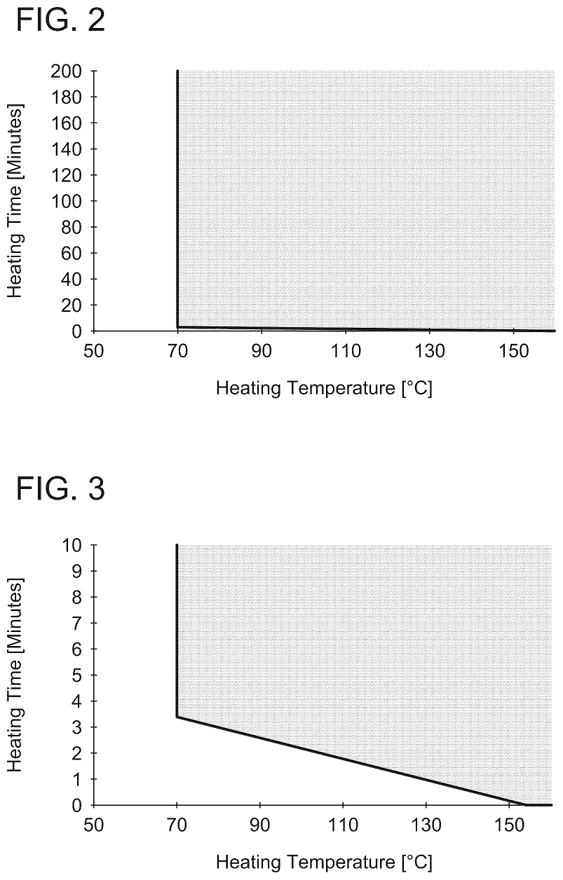

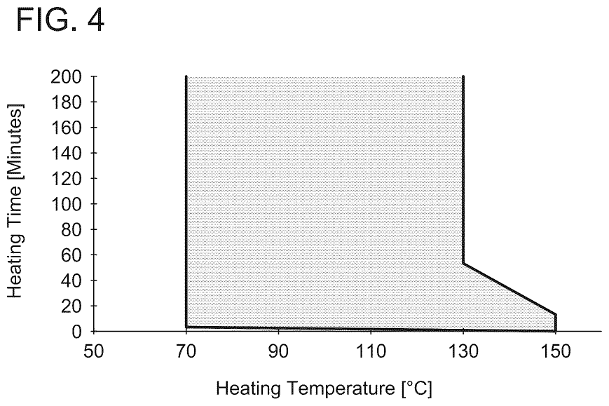

In the heating process, the medium 2 is heated according to a condition that satisfies a predetermined heating temperature and heating time. Said condition is a condition that satisfies the relationship of X≥70 and Y>−0.04X+6.165 (where Y>0) when the heating temperature is X[° C.] and the heating time is Y [min]. FIGS. 2 and 3 illustrate graphs that show a relationship between the heating temperature and the heating time in the heating process. In FIGS. 2 and 3, the area indicated by hatching is a range satisfying the above relationship. The controller 26 commands the heating temperature of the medium 2 to the controller 34 based on the input process execution instruction, while controlling the conveying speed of the medium 2 passing through the conveyance path 100. For example, when the controller 26 sends a command to the controller 34 to control the heating temperature of the medium 2 to 70° C., the controller 26 adjusts the conveying speed of the medium 2 passing through the conveyance path 100 by controlling the operation of the first roller pair(s) 20, etc. so that the heating time is about 202 seconds or longer. The upper limit of the heating temperature in the heating process is not particularly limited, but may be 150° C. or lower, for example. By setting the heating temperature to 150° C. or lower, discoloration of the medium 2 due to the heating process can be suppressed, while still providing the effect of suppressing beading. When the heating temperature is 130° C. or higher and 150° C. or lower, the heating treatment may be performed so that the relationship Y<−2X+313 is further satisfied. In FIG. 4, the area indicated by hatching is a range that further satisfies the above relationship. By adjusting the heating time to satisfy the above relationships, discoloration of the medium 2 can be further suppressed. The heating time is, for example, a time from the time when the downstream end of the medium 2 enters a section below the heating portion 32 to the time when the downstream end of the medium 2 exits the section below the heating portion 32 in the process of transporting the medium 2. The process execution instruction may be an instruction specifying both the heating temperature and the heating time, or it may be an instruction specifying only one of the heating temperature and the heating time.

### (Application Process)

In the application step, ink is applied to a surface of a medium 2. The controller 44 controls the piezoelectric elements corresponding to the respective nozzles 42a, for example, based on the commands from the controller 26. By controlling said piezoelectric elements, for example, the controller 44 selectively ejects ink from each of the nozzles 42a toward the medium 2 passing below the head 42. As a result, ink is deposited on the surface of the medium 2.

When there are numerous minute irregularities on the surface of the medium 2, adjacent dots are more likely to agglomerate and thus beading is more likely to occur. In the above surface treatment method, in the heating process, the medium 2 is heated under the condition that satisfies X≥70 and Y>−0.04X+6.165 (where Y>0). In other words, in the surface treatment method described above, higher energy is applied to the medium 2 in the heating process than in various treatments generally performed on the medium 2. Examples of the generally performed treatments include corona treatment, plasma treatment, preheating, and ink drying. The surface layer of the medium 2 comprises a coating layer containing a binder. Therefore, by implementing the heating process, the binder contained in the coating layer is softened and the surface of the coating layer is smoothed. That is, the micro irregularities that may exist on the surface of the coating layer are reduced. As a result, when ink is applied to the surface of the coating layer, the wettability of the ink is improved, and the ink is applied more easily and evenly to the surface of the coating layer. As a result, the above-described surface treatment method can be considered to be capable of suppressing ink beading.

### (Correspondence Relationships)

The heater 30 and the applier 40 are an example of “manufacturing apparatus configured to manufacture a treated medium by performing a treatment on a medium”. The surface treatment system 10 is an example of “manufacturing system configured to manufacture a treated medium by performing a treatment on a medium”. The surface treatment method is an example of “method of manufacturing a treated medium by performing a treatment on a medium”.

### Examples

Next, the art disclosed herein will be specifically described by means of examples and comparative examples. However, the art disclosed herein is not limited in any way to these examples.

### (Measurement of Peak Density Spd)

First, each of the media listed in Tables 1 to 4 was placed on a metal tray with the coating layer arranged as the top surface. The metal tray on which the medium was placed was placed in a DX402 dry oven manufactured by Yamato Scientific Co, Ltd. and was heated at 150° C. for 60 minutes. Each of the medium before and after heating was cut into a 5 cm×5 cm piece, and Spd was measured for each piece using a device VK-X1100 manufactured by Keyence Corporation using a test method compliant with ISO 25178. The Spd of each medium after heating and a rate of change in Spd of each medium before and after heating are shown in Tables 1 to 4, respectively.

The following describes the notation of each medium in Tables 1 to 4.

OK Ball (manufactured by Oji Materia Co., Ltd.; basis weight: 350 g/m²)

S Pearl Card (manufactured by Mitsubishi Paper Mills, Ltd., basis weight: 350 g/m²)

MARICOAT (Hokuetsu Corporation, basis weight: 350 g/m²)

Suncoat (manufactured by Oji Materia Co., Ltd.; basis weight: 350 g/m²)

### (Preparation of Heated Samples)

For each example, the medium shown in Tables 1 to 4 was placed on a metal tray with the coating layer arranged as the top surface. The metal tray on which the medium was placed was placed in the DX402 dry oven manufactured by Yamato Scientific Co, Ltd., and a heating treatment was performed on the medium with the heating time and heating temperature shown in Tables 1 to 4. The medium was then cooled to room temperature and used as a heated sample. In each example, the medium that had not been heat-treated was used as an unheated sample.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| Heating | Heating | 70 | 70 | 80 | 80 | 80 | 100 | 100 | 100 | 120 | 120 |
| Condition | Temperature (° C.) | | | | | | | | | | |
| | Heating Time (minutes) | 4.0 | 5.0 | 2.5 | 60.0 | 180.0 | 2.0 | 10.0 | 20.0 | 1.0 | 60.0 |
| Medium | | OK ball | OK ball | OK ball | OK ball | OK ball | OK ball | OK ball | OK ball | OK ball | OK ball |
| Surface Free Energy (mN/m) | | 57.6 | 57.6 | 57.6 | 57.6 | 57.6 | 57.6 | 57.6 | 57.6 | 57.6 | 57.6 |
| Spd after Heating | | 270.0 | 270.0 | 270.0 | 270.0 | 270.0 | 270.0 | 270.0 | 270.0 | 270.0 | 270.0 |
| at 150° C. for 60 minutes (mm⁻²) | | | | | | | | | | | |
| Rate of Change in Spd before and after | | −28.2 | −28.2 | −28.2 | −28.2 | −28.2 | −28.2 | −28.2 | −28.2 | −28.2 | −28.2 |
| Heating at 150° C. for 60 minutes (%) | | | | | | | | | | | |
| Maximum Print Duty (before Heating) | | 60 | 60 | 60 | 60 | 60 | 60 | 60 | 60 | 60 | 60 |
| Maximum Print Duty (after Heating) | | 70 | 70 | 70 | 70 | 70 | 70 | 70 | 70 | 70 | 70 |
| Evaluation | Image Quality | A | A | A | A | A | A | A | A | A | A |
| | Improvement Effect | | | | | | | | | | |
| | Discoloration of Medium | A | A | A | A | A | A | A | A | A | A |

TABLE 2

| | | Exam- | Exam- | Exam- | Exam- | Exam- | Exam- | Exam- | Exam- | Exam- | Exam- |
|---|---|---|---|---|---|---|---|---|---|---|---|
| | | ple 11 | ple 12 | ple 13 | ple 14 | ple 15 | ple 16 | ple 17 | ple 18 | ple 19 | ple 20 |
| Heating | Heating | 120 | 130 | 130 | 130 | 140 | 140 | 140 | 150 | 150 | 150 |
| Condition | Temperature (° C.) | | | | | | | | | | |
| | Heating Time (minutes) | 120.0 | 20.0 | 50.0 | 60.0 | 20.0 | 40.0 | 50.0 | 0.5 | 5.0 | 15.0 |
| Medium | | OK ball | OK ball | OK ball | OK ball | OK ball | OK ball | OK ball | OK ball | OK ball | OK ball |
| Surface Free Energy (mN/m) | | 57.6 | 57.6 | 57.6 | 57.6 | 57.6 | 57.6 | 57.6 | 57.6 | 57.6 | 57.6 |
| Spd after Heating | | 270.0 | 270.0 | 270.0 | 270.0 | 270.0 | 270.0 | 270.0 | 270.0 | 270.0 | 270.0 |
| at 150° C. for 60 minutes (mm⁻²) | | | | | | | | | | | |
| Rate of Change in Spd before and after | | −28.2 | −28.2 | −28.2 | −28.2 | −28.2 | −28.2 | −28.2 | −28.2 | −28.2 | −28.2 |
| Heating at 150° C. for 60 minutes (%) | | | | | | | | | | | |
| Maximum Print Duty (before Heating) | | 60 | 60 | 60 | 60 | 60 | 60 | 60 | 60 | 60 | 60 |
| Maximum Print Duty (after Heating) | | 70 | 70 | 70 | 70 | 70 | 70 | 70 | 70 | 70 | 70 |
| Evaluation | Image Quality | A | A | A | A | A | A | A | A | A | A |
| | Improvement Effect | | | | | | | | | | |
| | Discoloration of Medium | A | A | A | B | A | A | B | A | A | B |

TABLE 3

| | | Exam- | Exam- | Exam- | Exam- | Exam- | Exam- | Exam- | Exam- | Exam- |
|---|---|---|---|---|---|---|---|---|---|---|
| | | ple 21 | ple 22 | ple 23 | ple 24 | ple 25 | ple 26 | ple 27 | ple 28 | ple 29 |
| Heating | Heating | 150 | 150 | 150 | 150 | 150 | 150 | 150 | 150 | 150 |
| Condition | Temperature (° C.) | | | | | | | | | |
| | Heating Time (minutes) | 20.0 | 40.0 | 60.0 | 20.0 | 40.0 | 20.0 | 40.0 | 20.0 | 40.0 |
| Medium | | OK ball | OK ball | OK ball | S Pearl Card | S Pearl Card | Maricoat | Maricoat | Suncoat | Suncoat |
| Surface Free Energy (mN/m) | | 57.6 | 57.6 | 57.6 | 47.6 | 47.6 | 44.1 | 44.1 | 41.9 | 41.9 |
| Spd after Heating | | 270.0 | 270.0 | 270.0 | 522.3 | 522.3 | 631.8 | 631.8 | 705.5 | 705.5 |
| at 150° C. for 60 minutes (mm⁻²) | | | | | | | | | | |
| Rate of Change in Spd before and after | | −28.2 | −28.2 | −28.2 | −39.2 | −39.2 | −7.8 | −7.8 | −1.7 | −1.7 |
| Heating at 150° C. for 60 minutes (%) | | | | | | | | | | |
| Maximum Print Duty (before Heating) | | 60 | 60 | 60 | 60 | 60 | 60 | 60 | 60 | 60 |
| Maximum Print Duty (after Heating) | | 100 | 100 | 120 | 70 | 70 | <70 | <70 | <70 | <70 |
| Evaluation | Image Quality | A | A | A | A | A | B | B | B | B |
| | Improvement Effect | | | | | | | | | |
| | Discoloration of Medium | B | B | B | A | A | A | A | A | A |

TABLE 4

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Heating | Heating Temperature (° C.) | 60 | 70 | 80 | 100 | 120 | 150 |
| Condition | Heating Time (minutes) | 180.0 | 3.0 | 2.0 | 1.5 | 0.5 | 0.3 |
| Medium | | OK ball | OK ball | OK ball | OK ball | OK ball | OK ball |
| Surface Free Energy (mN/m) | | 57.6 | 57.6 | 57.6 | 57.6 | 57.6 | 57.6 |
| Spd after Heating | | 270.0 | 270.0 | 270.0 | 270.0 | 270.0 | 270.0 |
| at 150° C. for 60 minutes (mm⁻²) | | | | | | | |
| Rate of Change in Spd before and after | | −28.2 | −28.2 | −28.2 | −28.2 | −28.2 | −28.2 |
| Heating at 150° C. for 60 minutes (%) | | | | | | | |
| Maximum Print Duty (before Heating) | | 60 | 60 | 60 | 60 | 60 | 60 |
| Maximum Print Duty (after Heating) | | 60 | 60 | 60 | 60 | 60 | 60 |
| Evaluation | Image Quality Improvement Effect | C | C | C | C | C | C |
| | Discoloration of Medium | A | A | A | A | A | A |

### (Evaluation of Media Discoloration)

For each example, the optical density of the heated sample and the optical density of the unheated sample were measured using an exact spectrophotometer manufactured by X-Rite, under the following conditions:

Light source: D₅₀, viewing angle: 2°, density measurement condition: MO, density status: status-T, density white reference: absolute value

The optical density difference ΔE of the heated sample relative to the unheated sample was calculated based on the CIEDE 2000 color difference formula. The calculated ΔE was evaluated for discoloration of the medium according to the following criteria. The evaluation results are shown in Tables 1 to 4.
A: ΔE less than 1.0
B: ΔE equal to or greater than 1.0

### (Evaluation of Image Quality Improvement Effect)

For each example, the heated and unheated samples were set in an MFC-J7500CDW printer manufactured by Brother Industries, Ltd. Using ink A having the composition shown in Table 5, the volume ejected from the inkjet head was adjusted to 10 μL per pixel, and multiple 10 mm×10 mm patch images were formed with a resolution of 600 dpi×600 dpi. Each patch image was formed while increasing the print duty in 10% increments, and whether or not beading occurred was visually confirmed. The print duty immediately before the print duty of the patch image in which beading was visually confirmed was set as the maximum print duty. The print duty means a ratio of a cumulative area printed on the medium to the area of the medium. A larger maximum print duty means that beading does not occur even if ink is applied more densely. The notation “<70” in Examples 26 to 29 means that although beading occurs slightly in the patch image with a print duty of 70%, the degree of beading is reduced compared to the patch image with a print duty of 70% in the unheated sample. In each example, the difference between the maximum print duty of the heated sample and the maximum print duty of the unheated sample was calculated, and image quality improvement effect was evaluated according to the following criteria. The maximum print duty of the heated and unheated samples in each example and the evaluation results are shown in Tables 1 to 4. In Table 5, the magenta resin-dispersed pigment is a water dispersion of C.I. Pigment Red 122 containing a resin dispersant. The numerical values in the columns showing each component indicate the content of the component in that column relative to the total amount of ink A, and the units are mass percentages.
A: Maximum print duty increased by 10% or more
B: Maximum print duty increased by more than 0% but less than 10%.
C: No change in maximum print duty

TABLE 5

| Components | Ink A |
|---|---|
| Magenta Resin-dispersed Pigment | 5.0 |
| Acrylic Resin | 10.0 |
| 1,2-Hexanediol | 5.0 |
| Dipropylene Glycol Monomethyl Ether | 2.0 |
| Silicone-based Surfactant | 0.5 |
| Water | Remainder |

As shown in Tables 1 to 3, in Examples 1 to 29, the maximum print duty increased by 10% or more due to the heat treatment. In other words, in Examples 1 to 29, the heat treatment resulted in a good image quality improvement effect.

In contrast, firstly, in Comparative Example 1, the heating temperature is lower than in each embodiment. In Comparative Example 1, OK ball, which is also used in the examples, is used as the medium. However, because the heating temperature is as low as 60° C., the binder in the coating layer does not soften sufficiently even after heating for 180 minutes. Due to this, the surface of the coating layer is not smoothed easily even after the heat treatment is executed. As a result, it can be assumed that the wettability of ink on the coating layer did not improve before and after the heat treatment and therefore the image quality improvement effect was not demonstrated.

In Comparative Examples 2 to 6, although the heating temperature was 70° C. or higher, as shown in FIG. 3, the relationship between the heating temperature and heating time in the heat treatment is outside the area indicated by hatching. More precisely, in Comparative Examples 2 to 6, the heating time is shorter than in each of the examples where the heating treatment was performed at the corresponding heating temperature. In Comparative Examples 2 to 6, even though the heat treatment was executed at a sufficient heating temperature, the heating time was excessively short and the temperature did not rise enough to soften the binder. Therefore, the surface of the coating layer is not smoothed easily even when the heat treatment is executed. It is presumed that the ink wettability on the coat layer did not improve before to after the heat treatment, and therefore the image quality improvement effect was not obtained.

Next, comparison between each example shows that Examples 14, 17, and 20 to 23 resulted in a slightly lower evaluation for discoloration of the medium compared to the other examples. The heat treatment in Example 14 was at 130° C. for 60 minutes, the heat treatment in Example 17 was at 140° C. for 50 minutes, and the heat treatment in Examples 20 to 23 was at 150° C. for 15 minutes or more, respectively. That is, in these examples, the relationship between the heating temperature and heating time in the heat treatment is outside the area indicated by the hatching in FIG. 4. More precisely, in these examples, the heating time is longer than in each of the examples where the heating process was performed at the corresponding heating temperature. It can be considered that, in these examples, although the image quality improvement effect was sufficiently demonstrated, the relatively long heating time relative to the heating temperature may have resulted in some discoloration of the medium. From these results, it was found that when the heat treatment is performed in a high temperature zone, the image quality improvement effect can be obtained while discoloration of the media is suppressed by performing the heat treatment for a moderate heating time.

In Examples 24 and 25, the heat treatment is performed under the same condition as in Examples 21 and 22, respectively, except that the media type is different. The medium of Examples 21 and 22, “OK Ball”, has a relatively large surface free energy of 57.6 [mN/m]. The “OK Ball” has a relatively small Spd of 270.0 [mm⁻²] after heating at 150° C. for 60 minutes, and the Spd decreased by 28.2% compared to before heating. The medium of Examples 24 and 25, “S Pearl Card”, has a relatively large surface free energy of 47.6 [mN/m]. The “S Pearl Card” has a relatively small Spd of 522.3 [mm⁻²] after heating at 150° C. for 60 minutes, and the Spd decreased by 39.2% compared to before heating. Thus, in Examples 24 and 25, as in Examples 21 and 22, the surface free energy of the coating layer of the medium is relatively large and the wettability of the ink on the coating layer is relatively high. In addition, since the Spd after heat treatment was suppressed to a suitably small value, local agglomeration of the ink was difficult to occur. As a result, it is considered that a good image quality improvement effect was obtained. It was found that although the “S Pearl Card” has a very large Spd value of about 859 before heating, the Spd decreased sufficiently by the heat treatment, and therefore beading was suitably suppressed.

In Examples 26 and 27, the heat treatment is performed under the same condition as in Examples 21 and 22, respectively, except that the type of the medium is different. The medium of Examples 26 and 27, “MARICOAT”, has a relatively small surface free energy of 44.1 [mN/m]. In addition, “MARICOAT” has a relatively large Spd of 631.8 [mm⁻²] after being heated at 150° C. for 60 minutes, and the Spd decreased by only 7.8% compared to before heating. Thus, in Examples 26 and 27, the surface free energy of the coating layer of the medium is relatively small and the wettability of the ink on the coating layer is relatively low. Also, the Spd after heat treatment did not decrease significantly, thus the ink was prone to localized agglomeration. These results show that a better image quality improvement can be obtained by using a medium with a relatively large surface free energy and having Spd that becomes relatively small after heating. Specifically, it can be seen that, by using a media with the surface free energy of 47 [mN/m] and Spd of 600 [mm⁻²] or less after undergoing heating at 150° C. for 60 minutes, a better image quality improvement effect can be achieved. Examples 28 and 29 yielded results exhibiting similar effects as those of Examples 26 and 27.

The above examples of the present disclosure have been described in detail, but these are only examples and do not limit the scope of the claims. The art described in the claims includes various variations and modifications of the specific examples illustrated above. Modifications of the above embodiments are listed below.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### (Modification 1)

In the above examples, the medium 2 simply needs to have a coating layer on a surface of at least one side of the substrate. For example, a coating layer may be provided on surfaces of both sides of the substrate.

### (Modification 2)

In the above-described embodiment, the surface treatment system 10 may include, instead of the feed tray 14, the feed roller 16, and the feed-out tray 24, a roller that supports the medium 2 and a roller that winds up the medium 2. In other words, the surface treatment system 10 may be a system employing a roll-to-roll configuration.

### (Modification 3)

In the above embodiment, the heater 30 and the applier 40 were configured as separate components, but the heater 30 and the applier 40 may be configured as a single unit.

### (Modification 4)

In the above embodiment, the applier 40 applies ink to the medium 2 by an inkjet method, but the applier 40 may also apply ink to the medium 2 by, for example, a blade coating method, a roll coating method, a spray coating method, or the like.

### (Modification 5)

In the above embodiment, the surface treatment system 10 may further comprise a drying device configured to dry the ink discharged onto the medium 2 passing through the conveyance path 100. The drying device may comprise, for example, a dryer, heat gun, oven, IR heater, etc. Instead of providing a drying device, the ink may be left for a predetermined period of time after the ink is deposited on the medium 2 in the surface treatment system 10 to evaporate a predetermined amount of water-containing component(s) in the ink. That is, after the ink is applied to the medium 2 in the surface treatment system 10, the ink on the medium 2 may be allowed to dry naturally without using a drying device. In other words, the surface treatment method may comprise a drying process after the application process.

### (Modification 6)

In the embodiment described above, the surface treatment system 10 may further comprise a cooling device configured to cool the medium 2 that has been heated by the heater 30. Instead of providing a cooling device, the medium 2 may be left to be cooled for a predetermined period of time after the medium 2 is heated in the surface treatment system 10. That is, after heating the medium 2 in the surface treatment system 10, the medium 2 may be allowed to naturally dissipate heat without a cooling device. In other words, the surface treatment method may comprise a cooling process after the heating process but before the application process.

### (Modification 7)

In the above embodiment, the heating time of the medium 2 by the heater 30 may be a time in the process of conveying the medium 2, for example, that spans from when the downstream end of the medium 2 enters the section below the heating portion 32 until the upstream end of the medium 2 exits the section below the heating portion 32, or a time during which the entire medium 2 in the conveying direction is located in the section below the heating portion 32. Alternatively, it can be a time during which the medium 2 is positioned inside the heater 30.

What is claimed is:

1. A method of manufacturing a treated medium by performing a treatment on a medium, wherein the medium is a paperboard in which a coating layer comprising a binder is disposed on a surface layer of the medium, the method comprising:
heating the medium; and
applying ink to the coating layer after the heating,
wherein
the heating comprises, when a heating temperature is X [° C.] and a heating time is Y [minutes], heating the medium such that a relationship of X≥70 and Y>−0.04X+6.165 (where Y>0) is satisfied.

2. The method according to claim 1, wherein
the heating comprises heating the medium such that a relationship of X≤150 is satisfied, and
when 130≤X≤150, the medium is heated such that a relationship of Y<−2X+313 is further satisfied.

3. The method according to claim 1, wherein a surface free energy of the coating layer is 47 mN/m or more.

4. The method according to claim 1, wherein the medium is constituted of a material such that, when the medium is heated at 150° C. for 60 minutes, the peak density Spd at a surface of the coating layer is reduced by 10% or more as compared with the peak density Spd before the heating.

5. The method according to claim 1, wherein the medium is constituted of a material such that, when the medium is heated at 150° C. for 60 minutes, the peak density Spd at a surface of the coating layer is 600 mm 2 or less.

6. The method according to claim 1, wherein
the applying comprises applying the ink to the coating layer by an inkjet method.

7. A manufacturing apparatus configured to manufacture a treated medium by performing a treatment on a medium, wherein the medium is a paperboard in which a coating layer comprising a binder is disposed on a surface layer of the medium, the manufacturing apparatus comprising:
a heater configured to heat the medium; and
an applier configured to apply ink to the coating layer after the medium has been heated by the heater,
wherein
the heater heats the medium such that, when a heating temperature is X [° C.] and a heating time is Y [minutes], a relationship of X≥70 and Y>−0.04X+6.165 (where Y>0) is satisfied.

8. The manufacturing apparatus according to claim 7, wherein
the heater heats the medium such that a relationship of X≤150 is satisfied, and
when 130≤X≤150, the heater heats the medium such that a relationship of Y<−2X+313 is further satisfied.

9. The manufacturing apparatus according to claim 7, wherein a surface free energy of the coating layer is 47 mN/m or more.

10. The manufacturing apparatus according to claim 7, wherein the medium is constituted of a material such that, when the medium is heated at 150° C. for 60 minutes, the peak density Spd at a surface of the coating layer which is reduced by 10% or more as compared with the peak density Spd before the medium is heated.

11. The manufacturing apparatus according to claim 7, wherein the medium is constituted of a material such that, when the medium is heated at 150° C. for 60 minutes, the peak density Spd at a surface of the coating layer is 600 mm⁻² or less.

12. The manufacturing apparatus according to claim 7, wherein the applier applies the ink to the coating layer by an inkjet method.

13. A manufacturing system configured to manufacture a treated medium by performing a treatment on a medium, wherein the medium is a paperboard in which a coating layer comprising a binder is disposed on a surface layer of the medium,
the manufacturing system comprising:
a heater configured to heat the medium; and
an applier configured to apply ink to the coating layer after the medium has been heated by the heater,
wherein
the heater heats the medium such that, when a heating temperature is X[C] and a heating time is Y [minutes], a relationship of X≥70 and Y>−0.04X+6.165 (where Y>0) is satisfied.

14. The manufacturing system according to claim 13, wherein
the heater heats the medium such that a relationship of X≤150 is satisfied, and
when 130≤X≤150, the heater heats the medium such that a relationship of Y<−2X+313 is further satisfied.

15. The manufacturing system according to claim 13, wherein a surface free energy of the coating layer is 47 mN/m or more.

16. The manufacturing system according to claim 13, wherein the medium is constituted of a material such that, when the medium is heated at 150° C. for 60 minutes, the peak density Spd at a surface of the coating layer is reduced by 10% or more as compared with the peak density Spd before the medium is heated.

17. The manufacturing system according to claim 13, wherein the medium is constituted of a material such that, when the medium is heated at 150° C. for 60 minutes, the peak density Spd at a surface of the coating layer is 600 mm⁻² or less.

18. The manufacturing system according to claim 13, wherein the applier applies the ink to the coating layer by an inkjet method.
